(19) United States
(12) Patent Application Publication
(10) Pub. No.: US 2025/0155657 A1
(43) Pub. Date: May 15, 2025

(54) OPTICAL CIRCUIT BOARD

(71) Applicant: KYOCERA Corporation, Kyoto-shi, Kyoto (JP)

(72) Inventor: Yoshinori NAKATOMI, Nagahama-shi, Shiga (JP)

(73) Assignee: KYOCERA Corporation, Kyoto-shi, Kyoto (JP)

(21) Appl. No.: 18/838,791

(22) PCT Filed: Feb. 21, 2023
(86) PCT No.: PCT/JP2023/006186

§ 371 Date: Aug. 15, 2024

(30) Foreign Application Priority Data
Feb. 22, 2022 (JP) 2022-025565

(51) Int. Cl. G02B 6/42

(52) U.S. Cl. CPC G02B 6/424

(57) ABSTRACT

An optical circuit board makes it possible to align positions of a core of an optical waveguide and a core of the optical component in a height direction with high accuracy, and to reduce transmission loss, when an optical component is mounted. According to the present disclosure, an optical circuit board includes a wiring board including an upper surface having a first mounting region and a second mounting region adjacent to the first mounting region and an optical waveguide located in the first mounting region. The optical waveguide includes first lower cladding, a first core, and first upper cladding from a side at which an upper surface of the wiring board is provided. The first lower cladding includes a first portion located in the first mounting region and a second portion located in the second mounting region. The first portion and the second portion have the same height.

### TECHNICAL FIELD

The present invention relates to an optical circuit board and an optical component mounting structure using the same.

### BACKGROUND OF INVENTION

In recent years, optical fiber allowing high speed communication of enormous amounts of data is being used for telecommunication. Transmission and reception of optical signals are performed between optical fiber and an optical component. Such an optical component is mounted on an optical circuit board as described in, for example, Patent Document 1.

### CITATION LIST

### Patent Literature

Patent Document 1: JP 6264832 B

### Summary

### Solution To Problem

According to the present disclosure, an optical circuit board includes a wiring board including an upper surface having a first mounting region and a second mounting region adjacent to the first mounting region and an optical waveguide located in the first mounting region. The optical waveguide includes first lower cladding, a first core, and first upper cladding from a side at which an upper surface of the wiring board is provided. The first lower cladding includes a first portion located in the first mounting region and a second portion located in the second mounting region. The first portion and the second portion have the same height.

According to the present disclosure, an optical component mounting structure includes the optical circuit board described above and an optical component located in the second mounting region. The optical component includes an optical transmission line including second upper cladding, a second core, and second lower cladding from the side at which the upper surface of the wiring board is provided. The second core includes a linear portion and a planar portion. When viewed from a side which the wiring board is provided, the second upper cladding includes a recessed portion including the planar portion as a bottom portion at a position overlapping the second portion. The planar portion located at the bottom portion is in contact with the second portion.

### BRIEF DESCRIPTION OF THE DRAWINGS

FIG. 1 is a plan view illustrating an optical component mounting structure in which an optical component and an electronic component are mounted on an optical circuit board according to an embodiment of the present disclosure.

FIG. 2 is an enlarged explanatory view for illustrating a cross section of a region X illustrated in FIG. 1.

FIG. 3 is a plan view of a region Y illustrated in FIG. 2 (excluding an optical component).

FIG. 4 is an explanatory diagram viewed from the wiring board side illustrating an example of the optical component mounted on the optical circuit board according to the embodiment of the present disclosure.

FIG. 5 is an explanatory view for illustrating a process of manufacturing the optical circuit board according to the embodiment of the present disclosure.

FIG. 6 is an explanatory view for illustrating a cross section of a region Z1 illustrated in FIG. 3 in a case where an optical component is mounted on the optical circuit board according to the embodiment of the present disclosure.

FIG. 7 is an enlarged explanatory view for illustrating a cross section of a region Z2 illustrated in FIG. 3 in a case where the optical component is mounted on the optical circuit board according to the embodiment of the present disclosure.

FIG. 8 is a plan view illustrating another form in which the optical component is mounted on the optical circuit board according to an embodiment of the present disclosure.

FIG. 9 is an enlarged explanatory view for illustrating cross sections of regions Z3 and Z4 illustrated in FIG. 8 in another form in which the optical component is mounted on the optical circuit board according to the embodiment of the present disclosure.

### DESCRIPTION OF EMBODIMENTS

When the optical component is mounted on the optical circuit board, positions (heights) of a core of an optical waveguide included in the optical circuit board and a core of the optical component are difficult to be aligned. Thus, alignment accuracy in the height direction between the core of the optical waveguide and the core of the optical component is low, and transmission loss increases. Thus, there is a demand for the optical circuit board in which positions of the core of the optical waveguide and the core of the optical component in the height direction can be aligned with high accuracy, and the transmission loss can be reduced.

In the optical circuit board according to the present disclosure, as described in the solution to problem section, the first lower cladding includes the first portion located in the first mounting region and the second portion located in the second mounting region, and the first portion and the second portion have the same height. As a result, according to the optical circuit board of the present disclosure, when the optical component is mounted, positions of the core of the optical waveguide and the core of the optical component in the height direction can be aligned with high accuracy, and the transmission loss can be reduced.

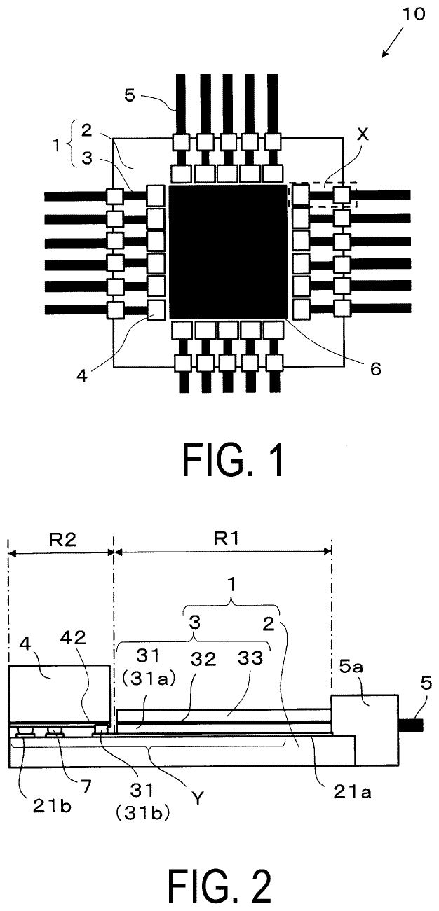

In an embodiment of the present disclosure, the optical circuit board will be described with reference to FIGS. 1 to 3. FIG. 1 is a plan view illustrating an optical component mounting structure 10 in which an optical component 4 and an electronic component 6 are mounted on an optical circuit board 1 according to the embodiment of the present disclosure.

In the embodiment of the present disclosure, the optical circuit board 1 includes a wiring board 2 and an optical waveguide 3. Examples of the wiring board 2 included in the optical circuit board 1 according to the embodiment include a wiring board typically used for an optical circuit board.

Although not specifically illustrated, such a wiring board 2 includes, for example, a core substrate and build-up layers layered on both surfaces of the core substrate. The core substrate is not particularly limited as long as the core substrate is made of a material having an insulation property. Examples of the material having an insulation property include resins such as an epoxy resin, a bismaleimide-triazine resin, a polyimide resin, and a polyphenylene ether resin. Two or more types of these resins may be mixed and used. The core substrate usually includes a through hole conductor for electrically connecting the upper and lower surfaces of the core substrate.

The core substrate may contain a reinforcing material. Examples of the reinforcing material include insulation fabric materials such as glass fiber, glass non-woven fabric, aramid non-woven fabric, aramid fiber, and polyester fiber. Two or more types of reinforcing materials may be used in combination. An inorganic filler made of, for example, silica, barium sulfate, talc, clay, glass, calcium carbonate, or titanium oxide may be dispersed in the core substrate.

The build-up layer has a structure in which insulation layers and electrical conductor layers are alternately layered. A part of the outermost electrical conductor layer (electrical conductor layer located on the upper surface of the wiring board 2) includes an electrical conductor layer 21a in which the optical waveguide 3 is located. The electrical conductor layer 21a is made of a metal such as copper. The insulation layer included in the build-up layer is not limited to any particular material as long as the insulation layer has the same insulation property as and/or a similar insulation property to the core substrate. Examples of the material having an insulation property include resins such as an epoxy resin, a bismaleimide-triazine resin, a polyimide resin, and a polyphenylene ether resin. Two or more types of these resins may be mixed and used.

When two or more insulation layers are present in the build-up layer, the insulation layers may be made of the same resin or may be made of different resins. The insulation layer included in the build-up layer and the core substrate may be made of the same resin or may be made of different resins. The build-up layer usually includes a via hole conductor for electrically connecting the layers. An inorganic filler made of, for example, silica, barium sulfate, talc, clay, glass, calcium carbonate, or titanium oxide may be dispersed in the insulation layer included in the build-up layer.

As illustrated in FIG. 2, a first mounting region R1 and a second mounting region R2 are located adjacent to each other on the surface of the wiring board 2. Although not illustrated, a solder resist may be partially located on the surface of the wiring board 2. The solder resist is made of resins, and examples of the resins include an acryl-modified epoxy resin.

As illustrated in FIG. 2, the optical waveguide 3 included in the optical circuit board 1 according to an embodiment is located on a surface of the electrical conductor layer 21a existing on a surface of the wiring board 2. The electrical conductor layer 21a is made of a metal such as copper. FIG. 2 is an enlarged explanatory view for illustrating a cross section of a region X illustrated in FIG. 1. The optical waveguide 3 has a structure in which first lower cladding 31, a first core 32, and first upper cladding 33 are layered in this order from the electrical conductor layer 21a.

The first lower cladding layer 31 included in the optical waveguide 3 is located over the surface of the wiring board 2, specifically on the surface of the electrical conductor layer 21a existing over the first mounting region RI and the second mounting region R2 on the surface of the wiring board 2. The material for forming the first lower cladding 31 is not limited, and examples thereof include resins such as an epoxy resin and a silicone resin.

The first upper cladding 33 included in the optical waveguide 3 is also made of resins such as an epoxy resin and a silicone resin, same as and/or similarly to the first lower cladding 31. The first lower cladding 31 and the first upper cladding 33 may be made of the same material or different materials. Furthermore, the first lower cladding 31 and the first upper cladding 33 may have the same thickness or different thicknesses. Each of the first lower cladding 31 and the first upper cladding 33 has a thickness of, for example, about 5 μm or more and 150 μm or less.

The first core 32 included in the optical waveguide 3 is a portion through which light having entered the optical waveguide 3 propagates. Specifically, an end surface of a second core 42 (linear portion 42a), which will be described later, included in the optical component 4 and an end surface of the first core 32 of the optical waveguide 3 are located to face each other. At the end surfaces, transmission and reception of optical signals are performed between the first core 32 and the second core 42 (linear portion 42a). The material forming the first core 32 is not limited and is set as appropriate in consideration of, for example, light transmission properties and wavelength characteristics of light propagating therethrough. Examples of the material include resins such as an epoxy resin and a silicone resin. The first core 32 has a thickness of from approximately 3 μm to approximately 50 μm, for example.

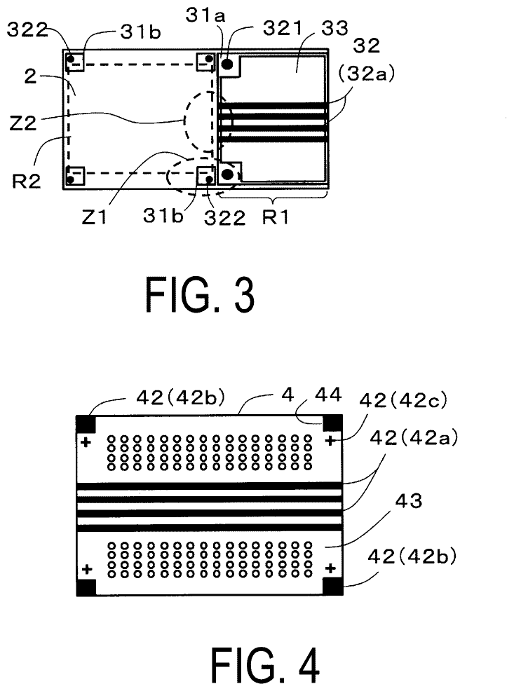

As illustrated in FIG. 3, the first lower cladding 31 includes a first portion 31a and a second portion 31b. FIG. 3 is a plan view of a region Y illustrated in FIG. 2 (excluding the optical component 4 and the first upper cladding 33 of the optical waveguide 3). The first portion 31a is located in the first mounting region R1, and the first core 32 is formed on the upper surface of the first portion 31a. On the other hand, the second portion 31b is located in the second mounting region R2 on which the optical component 4 is mounted.

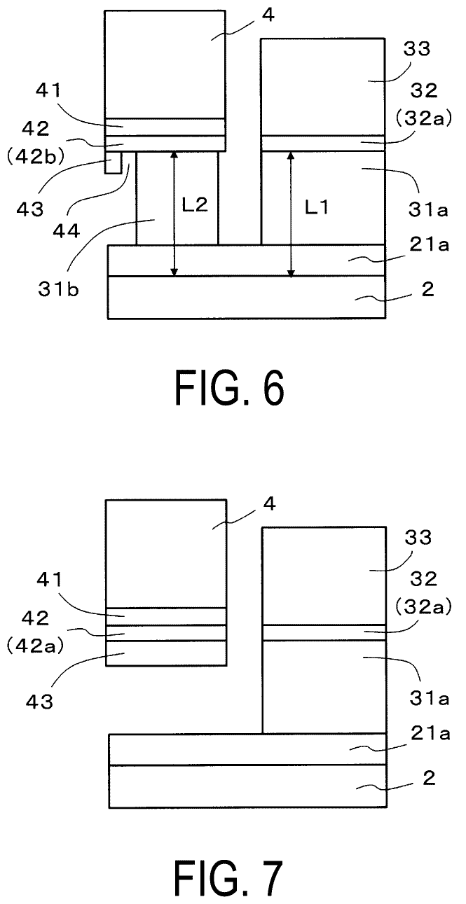

The height L1 of the first portion 31a and the height L2 of the second portion 31b of the first lower cladding 31 are the same. Since the first portion 31a and the second portion 31b have the same height, when the optical component 4 is mounted on the optical circuit board 1, the positions of the first core 32 of the optical waveguide 3 and the second core 42 (linear portion 42a) of the optical component 4 in the height direction (thickness direction of the optical circuit board 1) can be aligned with high accuracy. As a result, the transmission loss can be reduced. The height L1 of the first portion 31a can be defined as a distance from the upper surface of the wiring board 2 to the upper surface of the first portion 31a in the thickness direction of the optical circuit board 1 as illustrated in FIG. 6, for example. The height L2 of the second portion 31b can be defined as a distance from the upper surface of the wiring board 2 to the upper surface of the second portion 31b in the thickness direction of the optical circuit board 1 as illustrated in FIG. 6, for example. The expression “the height L1 of the first portion 31a and the height L2 of the second portion 31b are the same” includes not only a case where the heights completely coincide with each other but also a case where, for example, (the height L1 of the first portion 31a/the height L2 of the second portion 31b)×100 is in a range from 90% to 110% in consideration of manufacturing errors and the like.

The second portion 31b located in the second mounting region R2 may be provided in at least two places, for example. When the second portion 31b is provided at at least two positions, the optical component 4 is stably supported by the second portions 31b after an alignment is performed on the optical component 4.

The shape of the second mounting region R2 in a plan view is set in accordance with the shape of the optical component 4 to be mounted and is not limited. For example, as illustrated in FIG. 3, when the second mounting region R2 has a quadrangular shape including four corner portions in the plan view, the second portions 31b may be respectively located near the four corner portions of the second mounting region R2. The expression “near the corner portion” can be defined as, for example, a state in which the corner of the second mounting region R2 and the second portion 31b overlap each other. With such a configuration, the optical component 4 is aligned with higher accuracy with respect to the height direction of the optical circuit board 1 and is more stably supported by the second portions 31b.

As illustrated in FIG. 3, the first core 32 may include a covered portion 32a and a first exposed portion 321. The covered portion 32a is located on the surface of the first portion 31a, has a linear shape having two end surfaces, and is covered with the first upper cladding 33 except for the two end surfaces. The first exposed portions 321 are located on the surface of the first portion 31a, are located with the covered portion 32a interposed therebetween, and are not covered with the first upper cladding 33.

When the first core 32 includes the covered portion 32a and the first exposed portion 321, as illustrated in FIG. 3, the covered portion 32a is a portion through which light having entered the optical waveguide 3 propagates. Specifically, the end surface of the second core 42 (linear portion 42a) included in the optical component 4 and the end surface of the covered portion 32a of the optical waveguide 3 are located to face each other. At the end surfaces, transmission and reception of optical signals are performed between the covered portion 32a and the second core 42 (linear portion 42a).

The first exposed portion 321 functions as an alignment mark for the alignment in the planar direction when the optical component 4 is mounted on the optical circuit board 1. For the alignment in the height direction, the second portion 31b is used as described above.

As illustrated in FIG. 3, the first core 32 may include a second exposed portion 322. The second exposed portion 322 is located on the surface of the second portion 31b and is not covered with the first upper cladding 33. The second exposed portion 322 is located in a portion visible even after the optical component 4 is mounted, and functions as an alignment mark when another component is mounted. As will be described later, when the second core 42 of the optical component 4 and the first core 32 of the optical waveguide 3 are adiabatically coupled to each other, the second exposed portion 322 is in contact with and supports the optical component 4.

According to the present disclosure, a method for manufacturing the optical circuit board is not particularly limited as long as the optical circuit board having the structure described above can be manufactured. According to an embodiment of the present disclosure, the manufacturing method for the optical circuit board 1 includes the following steps (a) to (e).

Step (a): preparing the wiring board having the first mounting region and the second mounting region adjacent to each other.

Step (b): forming the first portion of the first lower cladding in the first mounting region and the second portion of the first lower cladding in the second mounting region with the same raw material.

Step (c): forming the first core along the upper surface of the first portion of the first lower cladding.

Step (d): forming the first core covering the upper surface of the first portion of the first lower cladding and the first upper cladding.

Step (e): grinding the end surfaces of the first portion of the first lower cladding, the first core, and the first upper cladding to form the optical waveguide.

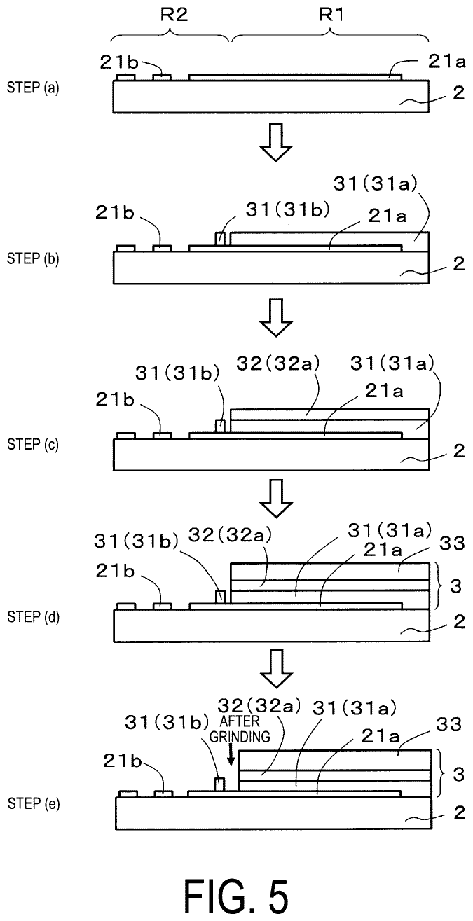

In step (a), as illustrated in FIG. 5, the wiring board 2 is prepared. The wiring board 2 has, on its upper surface, the first mounting region R1 and the second mounting region R2 adjacent to each other. The first mounting region R1 of the wiring board 2 includes the electrical conductor layer 21a, which is a part of the electrical conductor layer located on the uppermost face (the electrical conductor layer located on the upper surface of the wiring board 2). The second mounting region R2 of the wiring board 2 includes a pad 21b, which is a part of the electrical conductor layer located on the outermost face. The electrical conductor layer 21a and the pad 21b are made of metals such as copper.

Next, in step (b), as illustrated in FIG. 5, the first portion 31a of the first lower cladding 31 is formed in the first mounting region R1 and the second portion 31b of the first lower cladding 31 is formed in the second mounting region R2 with the same raw material. Specifically, a resin layer made of a resin such as an epoxy resin or a silicone resin is layered to cover the first mounting region R1 and the second mounting region R2. Then, exposure and development are performed to simultaneously form the first portion 31a of the first lower cladding 31 and the second portion 31b of the first lower cladding 31.

Next, in step (c), as illustrated in FIG. 5, the first core 32 is formed along the upper surface of the first portion 31a of the first lower cladding 31. As described above, the first core 32 is made of a resin such as an epoxy resin or a silicone resin. The first core 32 includes the covered portion 32a having a linear shape and performing transmission and reception of optical signals to and from the optical component 4, and may include, as necessary, the first exposed portion 321 and/or the second exposed portion 322 that are not covered with the first upper cladding 33. In FIG. 5, the first exposed portion 321 and the second exposed portion are not illustrated.

Next, in step (d), as illustrated in FIG. 5, the first upper cladding 33 is formed to cover the upper surface of the first portion 31a of the first lower cladding 31 and the first core 32. Like the first lower cladding 31, the first upper cladding 33 is also made of a resin such as an epoxy resin or a silicone resin. The first lower cladding 31 and the first upper cladding 33 may be made of the same material or different materials. Furthermore, the first lower cladding 31 and the first upper cladding 33 may have the same thickness or different thicknesses.

Next, in step (e), as illustrated in FIG. 5, the end surfaces of the first portion 31a of the first lower cladding 31, the covered portion 32a of the first core 32, and the first upper cladding 33 are grounded to form the optical waveguide 3.

In the manner described above, the optical circuit board 1 according to an embodiment is obtained. In the optical circuit board 1 according to the embodiment, the first portion 31a and the second portion 31b of the first lower cladding 31 have the same height. Since the first portion 31a and the second portion 31b have the same height, when the optical component 4 is mounted on the optical circuit board 1, the positions of the first core 32 (covered portion 32a) of the optical waveguide 3 and the second core 42 (linear portion 42a) of the optical component 4 in the height direction can be aligned with high accuracy. As a result, the transmission loss can be reduced.

In the optical circuit board according to the present disclosure, when a plurality of the second portions 31b are provided, the optical component 4 can be stably supported, and the alignment accuracy with respect to the height direction of the optical circuit board 1 is further improved. Specifically, when the second mounting region R2 has a quadrangular shape, as illustrated in FIG. 3, the second portions 31b may be respectively located near the four corner portions of the second mounting region R2, or may be respectively located on the sides of the quadrangular shape. The size of the second portion 31b is not limited as long as it does not interfere with the mounting and transmission of the optical component 4. For example, in the plan view, the second portions 31b may be respectively provided to be located on sides of the quadrangular shape in an elongated manner.

The optical component mounting structure of the present disclosure will be described. As illustrated in FIG. 1, according to an embodiment of the present disclosure, the optical component mounting structure 10 has a structure in which the optical component 4 and an electronic component 6 are mounted on the optical circuit board 1 according to an embodiment. According to the embodiment, the optical component 4 mounted on the optical component mounting structure 10 includes the optical transmission line. Examples of the optical component 4 including such an optical transmission line include a silicon photonics device. Examples of the electronic component 6 include an application specific integrated circuit (ASIC) and a driver IC.

As illustrated in FIG. 2, the optical component 4 is electrically connected to the pad 21b located in the second mounting region R2 of the wiring board 2 via a solder 7. The pad 21b is a part of the electrical conductor layer located on the upper surface of the wiring board 2.

As illustrated in FIGS. 6 and 7, the optical component 4 included in the optical component mounting structure 10 according to the embodiment includes the optical transmission line including second upper cladding 43, the second core 42, and second lower cladding 41 from the upper surface side of the wiring board 2. FIG. 4 is an explanatory diagram viewed from the wiring board side 2 illustrating an example of the optical component 4 mounted on the optical circuit board 1 according to the embodiment. FIG. 6 is an explanatory view for illustrating a cross section of a region Z1 illustrated in FIG. 3 in a case where the optical component 4 is mounted on the optical circuit board 1 according to the embodiment. FIG. 7 is an enlarged explanatory view for illustrating a cross section of a region Z2 illustrated in FIG. 3 in a case where the optical component 4 is mounted on the optical circuit board 1 according to the embodiment.

Examples of the optical component 4 include, for example, a silicon photonics device. When the optical component 4 is the silicon photonics device, the second core 42 included in the silicon photonics device is made of, for example, silicon (Si), and the second lower cladding 41 and the second upper cladding 43 are made of, for example, silicon dioxide (SiO₂). The silicon photonics device may further include a passivation film, a light source, and a photodetector (not illustrated).

The second lower cladding 41 and the second upper cladding 43 may have the same thickness or different thicknesses. Each of the second lower cladding 41 and the second upper cladding 43 has a thickness of, for example, about 1 μm or more and 20 μm or less.

The second core 42 includes the linear portion 42a and a planar portion 42b. The linear portion 42a and the planar portion 42b are normally formed in the same layer at the same time and thus have the same height. In FIG. 4, the linear portion 42a is illustrated so as to be visible for description, but is actually located between the second lower cladding 41 and the second upper cladding 43. Thus, when the optical component 4 is viewed from the wiring board 2 side, the linear portion 42a is covered with the second upper cladding 43 and is not visible.

As described above, the end surface of the linear portion 42a included in the second core 42 is located so as to face the end surface of the covered portion 32a included in the optical waveguide 3. At the end surfaces, transmission and reception of optical signals are performed between the covered portion 32a and the linear portion 42a. Thus, the thickness and the shape of the end surface of the linear portion 42a are appropriately set in accordance with the thickness and the shape of the end surface of the covered portion 32a included in the optical waveguide 3.

When the optical component 4 is viewed from the wiring board 2 side, the second upper cladding 43 includes a recessed portion 44 including the planar portion 42b as a bottom portion at a position overlapping the second portion 31b. The recessed portion 44 is located overlapping the second portion 31b. Thus, depending on the position of the second portion 31b, the recessed portion 44 may be a notch portion as illustrated in FIG. 4. Such a notch portion is also referred to as the “recessed portion” in this specification for convenience.

As illustrated in FIG. 6, the planar portion 42b located at the bottom of the recessed portion 44 and the second portion 31b are in contact with each other. As described above, the linear portion 42a and the planar portion 42b have the same height. Furthermore, the first portion 31a and the second portion 31b have the same height. Thus, by bringing the planar portion 42b located at the bottom of the recessed portion 44 and the second portion 31b into contact with each other, as illustrated in FIG. 7, the positions of the first core 32 (covered portion 32a) of the optical waveguide 3 and the second core 42 (linear portion 42a) of the optical component 4 in the height direction can be aligned with high accuracy. The optical component 4 is stably supported by the second portions 31b after the alignment.

The second core 42 includes island-shaped portions 42c located on the surface of the second lower cladding 41 with the linear portion 42a interposed therebetween. The island-shaped portion 42c functions as an alignment mark for the alignment in the planar direction when the optical component 4 is mounted on the optical circuit board 1. Specifically, the alignment in the planar direction is performed by the first exposed portions 321 included in the optical waveguide 3 and the island-shaped portions 42c included in the optical component 4.

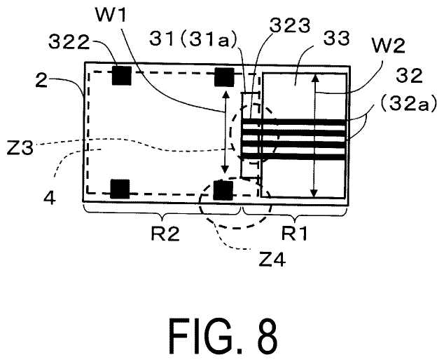

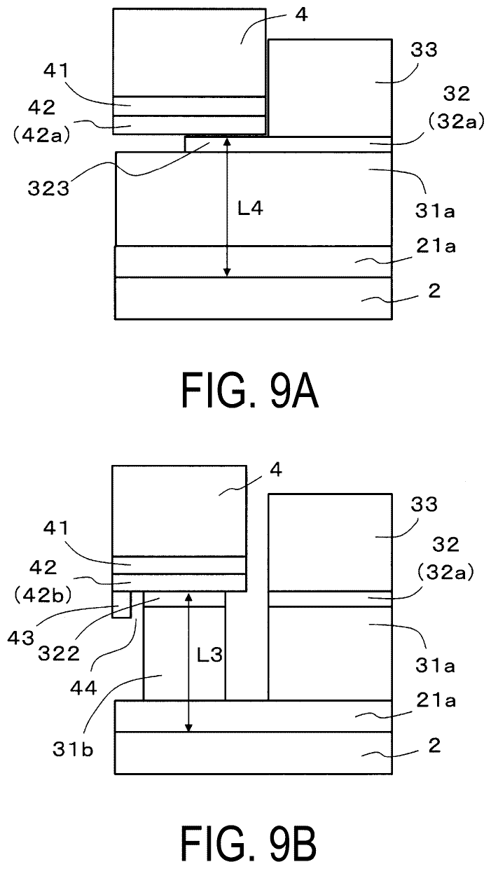

As illustrated in FIGS. 8, 9A and 9B, on the surface of the first portion 31a, the first core 32 may further include a third exposed portion 323 extending continuously from the covered portion 32a toward the second mounting region R2 and not covered with the first upper cladding 33. The height L3 of the second exposed portion 322 and the height L4 of the third exposed portion 323 are the same. The height L3 of the second exposed portion 322 can be defined as a distance from the upper surface of the wiring board 2 to the upper surface of the second exposed portion 322 in the thickness direction of the optical circuit board 1 as illustrated in FIG. 9B, for example. The height L4 of the third exposed portion 323 can be defined as a distance from the upper surface of the wiring board 2 to the upper surface of the third exposed portion 323 in the thickness direction of the optical circuit board 1 as illustrated in FIG. 9A, for example. The expression “the height L3 of the second exposed portion 322 and the height L4 of the third exposed portion 323 are the same” includes not only a case where the heights completely coincide with each other but also a case where, for example, (the height L3 of the second exposed portion 322/the height L4 of the third exposed portion 323)×100 is in a range from 90% to 110% in consideration of manufacturing errors and the like. FIGS. 9A and 9B are enlarged explanatory views for illustrating cross sections of regions Z3 and Z4 illustrated in FIG. 8 in a case where the optical component 4 is mounted on the optical circuit board 1 according to the embodiment.

According to the above-described structure, for example, the adiabatic coupling can be easily performed in which the second core 42 (linear portion 42a) of the optical component 4 and the third exposed portion 323 of the first core 32 overlap each other to perform transmission. In the optical circuit board in which the optical component 4 is mounted in the second mounting region R2, the height L1 from the upper surface of the wiring board 2 to the upper portion of the third exposed portion 323 and the height L2 from the upper surface of the wiring board 2 to the upper portion of the second exposed portion 322 are the same. Accordingly, the alignment in the height direction between the end surface of the first core 32 and the end surface of the second core 42 of the optical component 4 is facilitated.

As illustrated in FIG. 8, when the second mounting region R2 includes a plurality of the second exposed portions 322 located in the first lower cladding 31b, the optical component 4 can be easily mounted horizontally with respect to the wiring board 2.

As illustrated in FIG. 8, the width W1 of the first portion 31a of the first lower cladding 31 where the third exposed portion 323 of the first core 32 is located may be smaller than the width W2 of the first portion 32a of the first lower cladding 31 where the covered portion 31a of the first core 32 is located. When the region where the second core 42 of the optical component 4 is located is narrow, overlapping of the optical component 4 and the third exposed portion 323 is facilitated.

In the optical component mounting structure 10 according to the embodiment, for example, an electrical signal from the wiring board 2 is propagated to the light source included in the optical component 4 (silicon photonics device) via the solder 7. The light source unit emits light upon receiving the propagated electrical signal. The emitted optical signal is propagated to an optical fiber 5 connected via an optical connector 5a through the second core 42 (linear portion 42a) of the optical component 4 and the first core 32 (covered portion 32a) of the optical waveguide 3.

### REFERENCE SIGNS

1 Optical circuit board

2 Wiring board

21a Electrical conductor layer

21b Pad

3 Optical waveguide

31 First lower cladding

31a First portion

31b Second portion

32 First core

32a Covered portion

321 First exposed portion

322 Second exposed portion

323 Third exposed portion

33 First upper cladding

4 Optical component

41 Second lower cladding

42 Second core

42a Linear portion

42b Planar portion

42c Island-shaped portion

43 Second upper cladding

44 Recessed portion

5 Optical fiber

5a Optical connector

6 Electronic component

7 Solder

10 Optical component mounting structure

R1 First mounting region

R2 Second mounting region

1. An optical circuit board comprising:
a wiring board comprising an upper surface comprising a first mounting region and a second mounting region adjacent to the first mounting region; and
an optical waveguide located in the first mounting region,
wherein the optical waveguide comprises first lower cladding, a first core, and first upper cladding from a side at which the upper surface of the wiring board is provided,
the first lower cladding comprises a first portion located in the first mounting region and a second portion located in the second mounting region, and
a height of the first portion and a height of the second portion are the same.

2. The optical circuit board according to claim 1, further comprising an electrical conductor layer located on the upper surface of the wiring board, wherein both the optical waveguide and the second portion are located on the electrical conductor layer.

3. The optical circuit board according to claim 1, wherein
the first core comprises both a covered portion and a first exposed portion, both located in the first portion,
the covered portion has a linear shape having two end surfaces and is covered with the first upper cladding except for the end surfaces, and
the first exposed portions are located with the covered portion interposed therebetween in a plan view and are not covered with the first upper cladding.

4. The optical circuit board according to claim 1, wherein the first core comprises a second exposed portion located in the second portion and not covered with the first upper cladding.

5. The optical circuit board according to claim 1, wherein, in the plan view, the second mounting region has a quadrangular shape comprising four corner portions, and the second portions are located near the four corner portions.

6. The optical circuit board according to claim 4, wherein
the first core further comprises a third exposed portion located in the first portion, extending continuously from the covered portion toward a side at which the second mounting region is provided, and not covered with the first upper cladding, and
a height of the second exposed portion and a height of the third exposed portion are the same.

7. An optical component mounting structure comprising:
the optical circuit board according to claim 1; and
an optical component located in the second mounting region and comprising an optical transmission line,
wherein the optical transmission line comprises second upper cladding, a second core, and second lower cladding from the side at which the upper surface of the wiring board is provided,
the second core comprises a linear portion and a planar portion,
when viewed from a side at which the wiring board is provided, the second upper cladding comprises a recessed portion comprising the planar portion as a bottom portion at a position overlapping the second portion, and
the planar portion located at the bottom portion and the second portion are in contact with each other.

8. The optical component mounting structure according to claim 7, wherein an end surface of the linear portion of the second core faces an end surface of the covered portion of the first core.

9. An optical component mounting structure comprising:
the optical circuit board according to claim 6; and
an optical component located in the second mounting region and comprising an optical transmission line,
wherein the optical transmission line comprises second upper cladding, a second core, and second lower cladding from the side at which the upper surface of the wiring board is provided,
the second core comprises a linear portion and a planar portion,
when viewed from a side at which the wiring board is provided, the second upper cladding comprises a recessed portion comprising the planar portion as a bottom portion at a position overlapping the second portion,
the planar portion located at the bottom portion and the second exposed portion are in contact with each other, and
the linear portion of the second core and the third exposed portion are in contact with each other.

10. The optical component mounting structure according to claim 7, wherein the second core comprises island-shaped portions located on a surface of the second lower cladding with the linear portion interposed therebetween.
